(19) United States
(12) Patent Application Publication
(10) Pub. No.: US 2021/0001560 A1
(43) Pub. Date: Jan. 7, 2021

(54) IMPACT MITIGATING STRUCTURE

(71) Applicant: Oxford University Innovation Limited, Oxford (GB)

(72) Inventors: James E.T. COOK, Oxford (GB); Antoine JERUSALEM, Oxford (GB); Clive SIVIOUR, Oxford (GB)

(21) Appl. No.: 16/975,265

(22) PCT Filed: Feb. 27, 2019
(86) PCT No.: PCT/GB2019/050551

§ 371 Date: Aug. 24, 2020

(30) Foreign Application Priority Data
Feb. 27, 2018 (GB) 1803206.0

(51) Int. Cl. B29C 64/393; B33Y 50/02; B33Y 80/00; A42B 3/12; A42C 2/00

(52) U.S. Cl. CPC B29C 64/393; B33Y 50/02; B29L 2031/4821; A42B 3/124; A42C 2/00; B33Y 80/00

(57) ABSTRACT

A method of designing an impact mitigating structure. The method determines the force exerted by an object on the structure (11) as a function of the distance by which the object displaces a surface of the structure during impact. The method calculates a ratio of the integral of the force exerted by the object on the structure with respect to the distance by which the object displaces the surface of the structure during impact to the product of the maximum force exerted by the object on the structure during the impact and the total distance by which the object displaces the surface of the structure during the impact. The method also determines the respective values of characteristic variables of the structure that maximise the ratio for use in designing the structure.

This invention relates to an impact mitigating structure, in particular to a wearable impact mitigating structure for protecting the wearer from injury. The invention also relates to a method of designing an impact mitigating structure and a method of manufacturing an impact mitigating structure.

Injury to a person or damage to an object can occur when the person or object is subjected to an impact of sufficient magnitude. Considerable developmental effort has been expended in order to produce materials and structures that provide protection from potentially damaging or injurious impacts.

Impact protection is particularly important for preventing head injury. A blow to the head can result in traumatic brain injury (TBI). A brain trauma may occur as a consequence of either a focal impact upon the head, a sudden acceleration or deceleration within the cranium, or a combination of both impact and movement. TBI can cause long-term health conditions for which there may be limited treatment options. Other head injuries may include skin lacerations or skull fracture.

A common cause of head injury is participation in sports. For example, a fall from riding a bicycle may result in the rider's head striking a solid unyielding object or surface. In order to help prevent such injuries, helmets are customary or mandatory in many sports, such as cycling, motorcycling, horse riding, rock climbing and American Football, and also winter or ice sports such as skating, ice hockey and skiing. Another common cause of head injury is an impact caused by a falling object on a building or construction site.

WO 2016/125105 discloses an impact absorbing helmet that includes a hollow cell structure as an inner impact resistant liner. Such a structure helps to increase the energy dissipated over a given displacement by a helmet containing the structure when involved in an impact, while limiting the force transmitted to the wearer.

The present invention seeks to provide an improved impact mitigating structure and a method for designing such a structure.

When viewed from a first aspect the invention provides a method of designing an impact mitigating structure; the method comprising:
determining the force exerted by an object on the impact mitigating structure as a function of the distance by which the object displaces an outer surface of the impact mitigating structure during an impact of the object onto the outer surface of the impact mitigating structure;
calculating a ratio of the integral of the force exerted by the object on the impact mitigating structure with respect to the distance by which the object displaces the outer surface of the impact mitigating structure during the impact to the product of the maximum force exerted by the object on the impact mitigating structure during the impact and the total distance by which the object displaces the outer surface of the impact mitigating structure during the impact; and
determining the respective values of one or more characteristic variables of the impact mitigating structure that maximise the ratio for use in designing the impact mitigating structure.

Thus the invention provides a method of designing an impact mitigating structure. The impact mitigating structure is designed by determining the force that the object exerts on the structure as a function of the displacement of the object into the structure during the impact.

This determination of the force is used to calculate the integral of the force with respect to the distance by which the object displaces the outer surface of the structure during the impact. The product of the maximum force that is exerted by the object against the structure and the total displacement of the object into the outer surface of the structure during the impact is also calculated (i.e. the rectangle that bounds the force-displacement curve for the object during the impact). This is then used to calculate the ratio of the integral to the product of the maximum force and total displacement.

In order to determine the respective values of one or more characteristic variables of the impact mitigating structure (which can then be used to design the structure), the ratio of the integral to the product of the maximum force and total displacement is maximised, e.g. by varying the value(s) of the one or more characteristic variables for the impact of the object on the structure. (As outlined below, other objective measures, instead of or as well as the ratio, could be used to determine the characteristic variables for designing the impact mitigating structure.)

It will be appreciated that by maximising the ratio and thus the area under the force-displacement curve for the impact mitigating structure during an impact (e.g. of a particular energy and which delivers a particular impulse) helps to optimise the load mitigation of the structure. Improving the load mitigation of a structure helps to improve the safety able to be provided by the structure, e.g. when it forms part of a helmet (and is thus able to help reduce the likelihood of TBI being inflicted in an impact). This is because minimising the force helps to reduce the peak acceleration experienced by the structure during the impact (and thus the peak deceleration experienced by the impacting object), which helps to reduce the likelihood of an injury being sustained.

Furthermore, within safety constraints, for example, the optimisation of the one or more characteristic variables of the impact mitigating structure helps to improve the performance of the structure. This is because, in at least preferred embodiments of the invention, one or both of the weight and the thickness of the impact mitigating structure may be able to be minimised during the optimisation of the one or more characteristic variables, such that the same impulse can be sustained by the structure during an impact of an object on a thinner and/or lighter structure. Minimising the weight and/or the thickness of the impact mitigating structure may help to reduce the drag and/or improve the comfort of the structure for a user.

The optimisation of the respective values of the one or more characteristic variables of the impact mitigating structure also helps to provide an optimal load mitigation for a structure having certain constraints, e.g. its shape and the foreseeable uses (e.g. impact scenarios) for the structure. For example, a helmet may be desired to have a particular shape to fit a user's head and may be required to protect the user's head against a particular maximum force (e.g. to meet a safety standard). At least preferred embodiments of the invention are able to design an appropriate impact mitigating structure that will meet these criteria by evaluating the impact response of the structure through the optimisation method when maximising the force-displacement ratio.

The Applicant has found that structures designed using at least preferred embodiments of the method of the present invention may provide approximately a two-fold improvement in load mitigation compared to conventional foams that are conventionally used in crash helmets, for example. Furthermore, at least preferred embodiments of the method may allow for an impact mitigating structure to be customised to a particular set of requirements, e.g. such that a safety helmet may be designed in a manner that is customised to the particular shape of the head of the intended user.

The impact mitigating structure (e.g. to be designed) may be any suitable and desired structure able to absorb the impulse of an impact. In a preferred embodiment the structure comprises open voids. Preferably the impact mitigating structure comprises a cellular structure or a lattice structure. In one embodiment the impact mitigating structure comprises a honeycomb.

The cellular structure preferably comprises a plurality of tessellating cells, wherein the plurality of cells (e.g. each) have a plurality of side walls (that are, e.g., shared with adjacent cells). The cellular structure may comprise a plurality of vertices having a plurality of side walls extending therebetween. One or more of the vertices may be pre-weakened, e.g. to reduce the peak force experienced by the impact mitigating structure during an impact.

Preferably a (e.g. each) cell is hollow within its side walls. A cellular structure that has hollow voids may help to improve the ventilation of an impact mitigating structure, e.g. when used in a helmet.

Preferably the plurality of side walls extend perpendicularly to (and, e.g., between) the (e.g. inner and/or outer) surface of the impact mitigating structure, e.g. extending along a radial direction. Preferably the cells (e.g. each) have a (e.g. regular) polygon shape cross-section (e.g. in a direction substantially perpendicular to the direction in which the side walls extend). Thus preferably the side walls are substantially flat and, e.g., extend along the surface normal direction, perpendicular to local surface tangent.

Thus preferably the cells of the cellular structure comprise two-dimensional (e.g. tessellating) shapes that are projected in a direction along the normal of the (e.g. inner and/or outer) surface of the impact mitigating structure (e.g. “columnar” cells). It will be appreciated that when the surface of the impact mitigating structure is flat, this results in the cell walls extending parallel to each other; when the surface of the structure is curved, the cell walls will diverge from or converge towards each other.

In one embodiment the plurality of cells may each have the same cross-sectional shape, e.g. triangular, square or hexagonal, for such shapes that tessellate in this way. In some embodiments the plurality of cells may be tessellated from a plurality of different shapes, e.g. squares and octagons, triangles and squares, hexagons and triangles, or any combination thereof. As well as regular polygons the plurality of cells may include some irregular polygons or shapes. Preferably the tessellating cells form a periodic tiling.

The lattice structure preferably comprises a plurality of struts extending between a plurality of vertices. The struts may comprise walls (e.g. extending in two dimensions) but preferably the struts extend substantially only in one direction (i.e. in the direction between the vertices). Thus preferably the dimension of a (e.g. each) strut is significantly greater in the direction in which it extends between the vertices than the dimensions perpendicular to this direction. One or more of the vertices may be pre-weakened, e.g. to reduce the peak force experienced by the impact mitigating structure during an impact.

The impact mitigating structure (e.g. to be designed) may have any suitable and desired overall shape (having therewithin any suitable and desired structure, e.g., as outlined above).

Thus the impact mitigating structure may be flat, e.g. having a flat inner surface and/or a flat outer surface (the side of the surface designed to be incident against the impacting object). Therefore, when the impact mitigating structure comprises a cellular structure, preferably the side walls of the cells extend between the (e.g. flat) inner surface and the (e.g. flat) outer surface, and the side walls are substantially parallel to each other.

In a preferred set of embodiments the impact mitigating structure comprises a curved (e.g. convex) outer surface. The impact mitigating structure may also comprise a curved inner surface. Thus preferably the impact mitigating structure comprises a dome, a cap or a (e.g. hollow) hemisphere, e.g. when the structure is designed for a helmet.

Preferably the outer surface of the impact mitigating structure comprises a particular radius of curvature. As will be outlined below, preferably the radius of curvature is used as an input parameter (e.g. a constraint) when maximising the ratio, such that the (one or more characterising variables of the) impact mitigating structure is designed for the particular radius of curvature. This helps to provide the best load mitigation for an impact mitigating structure having a particular radius of curvature.

The skilled person will appreciate that designing impact mitigating structures having a curved outer surface presents additional challenges compared to a flat structure, that make it more difficult to design such structures so that they provide a flat force-displacement response during an impact. Conventional impact mitigating structures do not take into account their surface curvature when they are being designed, e.g. conventional helmets are not customised to the shape and size of a user's head. This leads to sub-optimal load mitigation and thus an increased risk of injury (e.g. when a user is wearing a conventional impact mitigating structure to protect themselves), or results in a structure which does not have very good performance characteristics.

When an object impacts against an impact mitigating structure having a curved outer surface, the contact area between the object and the impact mitigating structure is often not constant and may change. For example, when an impact mitigating structures having a convex outer surface impacts against a flat object (e.g. a helmet against a pavement), the contact area will increase as impact proceeds and the pavement displaces the outer surface of the structure. This has the consequence that the resultant force may not be proportional to the stress.

Furthermore, the modes of deformation may be different for different parts of the contact area between the impacting object and the curved outer surface, which may not be the case for a structure having a flat outer surface (where, for example, the mode(s) of deformation may be the same for the whole of the contact area during the impact). For example, the part of the impact mitigating structure directly beneath the impacting object may be subject to compression, whereas the part of the impact mitigating structure at the edges of the contact area may be subject to bending. The skilled person will appreciate that this is a complex process for which modelling from impacts of flat objects on flat impact mitigating structures cannot be used. This therefore makes it non-trivial to design an impact mitigating structure having a curved outer surface which provides safe protection against an impact.

Thus, in order to provide a (as close to) flat force-displacement profile for an impact during which the contact area between the object and the outer surface of the impact mitigating structure varies, it is a trade-off between the behaviour of the structure (optimised by determining the one or more characteristic variables of the structure) and the varying contact area. This helps to maintain the rectangular relationship of the force between the impacting object and the impact mitigating structure with distance, even when the contact area therebetween changes during the impact. Thus, at least preferred embodiments of the method of the present invention allow an impact mitigating structure to be designed for a particular surface curvature.

The radius of curvature of the outer surface of the impact mitigating structure may be constant, e.g. the impact mitigating structure may comprise a segment of a sphere (e.g. a segment of a spherical shell). In one embodiment the radius of curvature may vary over the (inner and/or outer) surface of the impact mitigating structure, e.g. the impact mitigating structure may be (e.g. ergonomically) shaped to conform to the shape of a user's body (or part thereof). Thus the radius of curvature of the outer and/or inner surface of the impact mitigating structure may have a particular maximum and/or minimum radius of curvature.

The force exerted by an object on the impact mitigating structure may be determined, as a function of the distance the object displaces the outer surface of the structure, in any suitable and desired way. In one embodiment the force exerted by an object on the impact mitigating structure is determined using experimental data, e.g. of an object impacting the impact mitigating structure.

The experimental data may comprise one or more of: uniaxial compression data, tension data, (e.g. quasi-static four-point) bending test data and (e.g. medium) strain rate compression test data of the impact mitigating structure (or a component thereof). Thus preferably the method comprises impacting an object on the impact mitigating structure to determine the force exerted by the object on the impact mitigating structure as a function of the distance by which the object displaces the outer surface of the impact mitigating structure during an impact of the object onto the outer surface of the impact mitigating structure.

Preferably multiple pieces of experimental data are collected, e.g. for different impact mitigating structures (e.g. having different values for the characteristic variable(s)), and/or for objects having different impact energies (e.g. different masses and/or impact speeds) and/or sizes.

In one embodiment the force exerted by an object on the impact mitigating structure is determined analytically or numerically. Preferably the model parameters in the analytical or numerical determination of the force are calibrated using the experimental data.

In one embodiment the force exerted by an object on the impact mitigating structure is determined by simulating the impact of an object on the impact mitigating structure. Thus preferably the method comprises simulating the impact of an object onto the impact mitigating structure to determine the force exerted by the object on the impact mitigating structure as a function of the distance by which the object displaces the outer surface of the impact mitigating structure during an impact of the object onto the outer surface of the impact mitigating structure.

The simulation may use experimental data as an input to or validation of the analytical or numerical simulation. Preferably the simulation uses finite element analysis.

The ratio of the integral of the force exerted by the object on the impact mitigating structure with respect to the distance by which the object displaces the outer surface of the impact mitigating structure during the impact to the product of the maximum force exerted by the object on the impact mitigating structure during the impact and the total distance by which the object displaces the outer surface of the impact mitigating structure during the impact is calculated. This evaluates the efficiency of the impact mitigating structure (e.g. having a particular value(s) for the characteristic variable(s)) as a load mitigator.

A high ratio indicates that the work that can be done for a given peak load (i.e. force) and displacement is helped to be maximised for an impact. It also indicates that for a required amount of work to be done, the peak load and displacement will be helped to be minimised. When the impact mitigating structure forms part of a protective device, e.g. a helmet, this helps to reduce (e.g. head) injuries. It also helps to improve the performance of the impact mitigating structure, e.g. by reducing the thickness and/or weight of the impact mitigating structure. A ratio of 1 (i.e. a rectangular load-displacement response) indicates that the structure is 100% efficient for an impacting object.

The one or more characteristic variables of the impact mitigating structure that are determined to maximise the ratio may comprise any suitable and desired variables that are characteristic (e.g. define the properties) of the impact mitigating structure.

In one embodiment the characteristic variable(s) comprise one or more of: the mass of the impact mitigating structure, the density of the structure, the dimension(s) of the structure, the radius of curvature of the (e.g. inner and/or outer surface of the) structure, the material(s) of the structure, the Young's modulus of the material, the Poisson's ratio of the material, the yield stress of the material and the strain hardening function of the material.

When the impact mitigating structure comprises a cellular structure (e.g. comprising a plurality of tessellating cells (e.g. each) having a plurality of side walls), preferably the characteristic variable(s) comprise one or more of: the thickness of the side walls (e.g. in a direction of the normal to the side wall), the characteristic length of the cells (e.g. the width (e.g. at the base of the structure) of a cell) (e.g. in a direction parallel to the (inner) surface of the structure (e.g. at the base of the structure)), the height of the cells (i.e. the thickness of the structure) (e.g. in a direction along the surface normal of the structure) and the (e.g. two-dimensional cross-sectional) shape of the cells.

When the impact mitigating structure comprises a lattice structure (e.g. comprising a plurality of struts extending between a plurality of vertices), preferably the characteristic variable(s) comprise one or more of: the length of the struts, the thickness of the struts and the (e.g. local, e.g. cross-sectional) geometry of the struts.

The value(s) of the characteristic variable(s) may be determined in a uniform manner across the impact mitigating structure (e.g. so that the characteristic variable(s) have the same value(s) for the whole of the impact mitigating structure). In one embodiment the value(s) of the characteristic variable(s) may be determined in a way that varies across the impact mitigating structure. For example, the value(s) of the characteristic variable(s) may be determined as a function of other(s) of the characteristic variable(s) or the one or more constraints (as outlined below). In particular, when the impact mitigating structure is curved, the value(s) of the characteristic variable(s) may be determined as a function of the radius of curvature of the (e.g. outer and/or inner) surface of the structure.

The respective values of the one or more characteristic variables of the impact mitigating structure that maximise the ratio may be determined in any suitable and desired way. The step of determining the respective values of the one or more characteristic variables of the lattice or cellular structure that maximise the ratio may comprise maximising the ratio as a function of the one or more characteristic variables of the impact mitigating structure, e.g. by varying the respective values of one or more characteristic variables to maximise the ratio.

In one embodiment the step of determining the respective values of the one or more characteristic variables of the impact mitigating structure that maximise the ratio (or optimise the objective measure, as appropriate) comprises repeating the steps of determining the force (or, e.g., acceleration) exerted by an object on the impact mitigating structure and calculating the ratio (e.g. the impact of the object on the impact mitigating structure is performed multiple times). Preferably the steps of determining the force exerted by an object on the impact mitigating structure and calculating the ratio are repeated for a plurality of different (e.g. sets of) respective values of (e.g. each of) the one or more characteristic variables, e.g. to calculate the respective ratios so that the optimum (e.g. set of) value(s) of the characteristic variable(s) that maximise the ratio may be determined. These repeated steps may include any preferable and/or optional features outlined herein, e.g. that are associated with the steps of determining the force exerted by an object on the impact mitigating structure and calculating the ratio.

The ratio (or other objective measure) may be maximised (or otherwise optimised, as appropriate) in any suitable and desired way, e.g. by repeating the steps as outlined above. In one embodiment the ratio is maximised numerically, e.g. using finite element analysis. This may use bilinear interpolation or (e.g. multiple) linear regression.

It will be appreciated that it may not always be possible, or at least feasible, to determine the absolute maximum of the ratio (or otherwise optimise the objective measure) across all possible variations of the values of the characteristic variables. Thus preferably the respective values of the one or more characteristic variables of the impact mitigating structure that maximise the ratio are determined within one or more constraints. In this embodiment preferably the method comprises setting one or more constraints and maximising the ratio within the one or more constraints.

The one or more constraints may comprise upper and/or lower limits on each of the respective values of the one or more characteristic variables, e.g. a maximum and/or minimum radius of curvature of the (e.g. inner and/or outer surfaces of the) impact mitigating structure that correspond to typical dimensions of a human head. For a helmet, the minimum radius of curvature may be 60 mm and the maximum radius of curvature may be 140 mm (these correspond to typical dimensions of a human head).

The one or more constraints may comprise a maximum and/or minimum cell width of a cellular structure, e.g. a minimum of 10 mm and a maximum of 50 mm. Below a minimum cell width the cellular structure may become too dense; above a maximum cell width the cells of the cellular structure may become too large and thus give too much variability in the load response as a function of the impact location of the object owing to the space between the cell walls being significant and thus unpredictable.

The one or more constraints may comprise a maximum and/or minimum cell wall thickness of a cellular structure, e.g. a minimum of 0.4 mm and a maximum of 5 mm. A cell wall thickness below a minimum may result in a structure that is too fragile; a cell wall thickness above a maximum may become too dense.

The one or more constraints may comprise a maximum and/or minimum cell height of a cellular structure, e.g. a minimum of 10 mm and a maximum of 30 mm. A cell height below a minimum may risk densification during an impact, in turn increasing the force transmitted; a cell height above a maximum may provide too heavy an impact mitigating structure.

The one or more constraints may comprise a maximum and/or minimum relative density (which, for some structures, may be approximated by 2t/w, where t is the cell wall thickness and w is the cell width) of a cellular structure, e.g. a minimum of 0.025 and a maximum of 0.07. Structures below a minimum relative density may risk densification during an impact; above a maximum relative density may provide a structure that is too dense (e.g. denser than expanded polystyrene).

The one or more constraints may comprise a maximum number of repetitions of the steps of determining the force exerted by an object on the impact mitigating structure and calculating the ratio, which may be repeated for a plurality of different respective values of (e.g. each of) the one or more characteristic variables.

In one embodiment the constraint(s) comprise a safety standard, e.g. a maximum allowed deceleration or peak force when using the impact mitigating structure. For example, in the safety standard BS EN 1078, the maximum permitted deceleration for a bicycle helmet when involved in an impact is 250 g (where g is the acceleration due to gravity). For example, an impact mitigating structure that has a (e.g. set of) value(s) of the characteristic variable(s) that results in a peak force greater during the impact than that allowed by the safety standard may be discarded from consideration in helping to maximise the ratio.

In one embodiment the constraint(s) comprise a requirement to avoid densification, as this may lead to a spike in the force of the object on the impact mitigating structure. For example, an impact mitigating structure that has a (e.g. set of) value(s) of the characteristic variable(s) that results in densification during the impact may be discarded from consideration in helping to maximise the ratio.

It will be appreciated that the value(s) of the characteristic variable(s) that maximise the ratio may be a unique (e.g. set of) value(s). Alternatively (e.g. each of) the value(s) of the characteristic variable(s) may be determined as a range of the value(s). This may help to create a “design space” for the impact mitigating structure.

The method may be repeated (e.g. at least the steps of determining the force exerted by an object on the impact mitigating structure and calculating the ratio) for multiple different objects (e.g. of a plurality of different shapes, sizes, masses and/or velocities, etc.) impacting the impact mitigating structure, e.g. at a plurality of different locations on the impact mitigating structure. However, in one embodiment the same object (e.g. an object having a particular shape, size, mass and/or velocity, etc.) is used when the method is repeated in order to maximise the ratio.

Preferably the object is chosen to have a particular mass and a particular velocity to provide the maximum impulse that is required for testing an impact mitigating structure to meet a safety standard. In one embodiment, the impacting object has a mass of 5 kg and a velocity of 5.4 m s⁻¹ (e.g. to meet safety standard BS EN 1078).

In one embodiment the objective measure is the peak acceleration of the impact mitigating structure during the impact of the object with the impact mitigating structure.

In one embodiment the objective measure is the Head Injury Criterion (HIC) of the impact mitigating structure during the impact of the object with the impact mitigating structure. The HIC is a measure of the likelihood of head injury arising from an impact and is defined as:

$$HIC = {\{ {[ \frac{1}{{t}_{2} - {t}_{1}} {\int }_{{t}_{1}}^{{t}_{2}} a ( t ) dt ]}^{2.5} ( {t}_{2} - {t}_{1} ) \}}_{max}$$

where t₁ and t₂ are the initial and final times (measured in seconds) of the interval during which the HIC attains a maximum value, and the acceleration, a, of the impact mitigating structure is measured in units of standard gravity.

In one embodiment the objective measure is the normalised displacement, defined as the ratio of the indentation distance of an object impacting the impact mitigating structure (i.e. the distance by which the object displaces the outer surface of the impact mitigating structure relative to the inner surface) to the original thickness of the impact mitigating structure. Thus the normalised displacement provides a measure of how much a structure is compressed during an impact. It will be appreciated that a structure having a larger normalised displacement is able to absorb a greater amount of energy during an impact.

In one embodiment the objective measure is the initial peak stress (i.e. the strength) of the impact mitigating structure from the impact of the object with the impact mitigating structure.

It will be appreciated from the above that a number of different objective measures may be used to assess the effectiveness of a structure at mitigating an impact and thus when viewed from a further aspect the invention provides a method of designing an impact mitigating structure; the method comprising:
determining the acceleration of the impact mitigating structure during an impact of an object onto the outer surface of the impact mitigating structure;
calculating, using the acceleration, an objective measure of the ability of the impact mitigating structure to mitigate the impact of the object on the impact mitigating structure; and
determining the respective values of one or more characteristic variables of the impact mitigating structure that optimise the objective measure for use in designing the impact mitigating structure.

By optimising the objective measure, this can help to design an impact mitigating structure that has an optimised ability to mitigate the impact of an object on the impact mitigating structure. As will be appreciated by those skilled in the art, this aspect of the present invention can, and preferably does, include any one or more or all of the preferred and optional features of the present invention discussed herein, as appropriate. In particular, any preferred and optional features relating to the force outlined herein may also apply equally (if applicable) to the acceleration. Similarly, any preferred and optional features relating to the ratio outlined herein may also apply equally (if applicable) to the relevant objective measure.

Thus preferably the step of calculating the objective measure may comprise one or more of: calculating the peak acceleration of the impact mitigating structure during the impact of the object with the impact mitigating structure, calculating the HIC of the impact mitigating structure during the impact of the object with the impact mitigating structure, calculating the normalised displacement of the impact mitigating structure from the impact of the object with the impact mitigating structure, calculating the initial peak stress of the impact mitigating structure from the impact of the object with the impact mitigating structure, and calculating the ratio of the integral of the force exerted by the object on the impact mitigating structure with respect to the distance by which the object displaces the outer surface of the impact mitigating structure during the impact to the product of the maximum force exerted by the object on the impact mitigating structure during the impact and the total distance by which the object displaces the outer surface of the impact mitigating structure relative to the inner surface during the impact.

Thus preferably the method comprises determining the force exerted by the object on the impact mitigating structure as a function of the distance by which the object displaces the outer surface of the impact mitigating structure relative to the inner surface during the impact of the object onto the outer surface of the impact mitigating structure. Preferably the force is determined from the acceleration (e.g. as a function of time) of the impact mitigating structure during the impact.

Preferably the step of determining the respective values of one or more characteristic variables of the impact mitigating structure that optimise the objective measure for use in designing the impact mitigating structure may comprise one or more of: optimising the peak acceleration of the impact mitigating structure during the impact of the object with the impact mitigating structure, minimising the HIC of the impact mitigating structure during the impact of the object with the impact mitigating structure, optimising the normalised displacement of the impact mitigating structure from the impact of the object with the impact mitigating structure, optimising the initial peak stress of the impact mitigating structure from the impact of the object with the impact mitigating structure, and maximising the ratio of the integral of the force exerted by the object on the impact mitigating structure with respect to the distance by which the object displaces the outer surface of the impact mitigating structure during the impact to the product of the maximum force exerted by the object on the impact mitigating structure during the impact and the total distance by which the object displaces the outer surface of the impact mitigating structure relative to the inner surface during the impact, e.g. when the respective objective measure has been determined.

The method may be performed in any suitable and desired way and on any suitable and desired platform. In a preferred embodiment the method of designing the impact mitigating structure is a computer implemented method, e.g. the steps of the method are performed by processing circuitry.

The methods in accordance with the present invention may be implemented at least partially using software, e.g. computer programs. It will thus be seen that when viewed from further aspects the present invention provides computer software specifically adapted to carry out the methods described herein when installed on a data processor, a computer program element comprising computer software code portions for performing the methods described herein when the program element is run on a data processor, and a computer program comprising code adapted to perform all the steps of a method or of the methods described herein when the program is run on a data processing system.

The present invention also extends to a computer software carrier comprising such software arranged to carry out the steps of the methods of the present invention. Such a computer software carrier could be a physical storage medium such as a ROM chip, CD ROM, DVD, RAM, flash memory or disk, or could be a signal such as an electronic signal over wires, an optical signal or a radio signal such as to a satellite or the like.

It will further be appreciated that not all steps of the methods of the present invention need be carried out by computer software and thus from a further broad embodiment the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible, non-transitory medium, such as a computer readable medium, for example, diskette, CD ROM, DVD, ROM, RAM, flash memory or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic or optical, or transmitted using any communications technology, present or future, including but not limited to optical, infrared or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Once the above method of designing the impact mitigating structure has been performed (i.e. thus determining the respective values of the one or more characteristic variables of the impact mitigating structure), preferably the method comprises the step of manufacturing the impact mitigating structure using the respective values of the one or more characteristic variables of the impact mitigating structure that have been determined.

The impact mitigating structure may be manufactured in any suitable and desired way. Preferably the impact mitigating structure is manufactured using Additive Manufacturing, e.g. laser sintering. Additive Manufacturing allows types of structures to be designed and manufactured that were not able to be manufactured previously using conventional techniques, or may allow structures to be constructed more conveniently or cost effectively, e.g. for types of structures where the geometry changes significantly between each manufacturing process.

Thus preferably the method comprises generating a set of Additive Manufacturing instructions using the respective values of the one or more characteristic variables of the impact mitigating structure that have been determined; and preferably manufacturing the impact mitigating structure according to the Additive Manufacturing instructions.

The impact mitigating structure may be manufactured using and thus comprise any suitable and desired material. In one embodiment the impact mitigating structure is manufactured from and/or comprises a (e.g. elastomeric) material that deforms reversibly. Such materials may be used when the impact mitigating structure forms part of a footwear. In another embodiment the impact mitigating structure is manufactured from and/or comprises a material that deforms irreversibly.

Preferably the impact mitigating structure is manufactured from and/or comprises a polymer, e.g. a polyamide, e.g. polyamide 11, or, e.g. an elastomer, e.g. a thermoplastic elastomer, e.g. a polyether block amide (PEBA), e.g. ST PEBA 2301. When the impact mitigating structure is manufactured using Additive Manufacturing, preferably the impact mitigating structure is manufactured using and/or comprises polyamide 11 powder (e.g. PA 1101) or ST PEBA 2301.

Preferably the invention also extends to an impact mitigating structure (e.g. a helmet) designed and, e.g., manufactured according to the method outlined above. As will be appreciated by those skilled in the art, this aspect of the present invention can, and preferably does, include any one or more or all of the preferred and optional features of the present invention discussed herein, as appropriate.

The impact mitigating structure may have any suitable and desired values for its characteristic variables. When the impact mitigating structure comprises a cellular structure, e.g. for a helmet, preferably the cell width is between 10 mm and 50 mm, e.g. between 20 mm and 40 mm, e.g. approximately 30 mm. Preferably the cell wall thickness is between 0.4 mm and 5 mm, e.g. between 1 mm and 3.5 mm, e.g. approximately 2 mm. Preferably the cell height is between 10 mm and 30 mm, e.g. between 15 mm and 25 mm, e.g. approximately 20 mm. Preferably the ratio of twice the cell wall thickness to the cell width (i.e. the “relative density”) is between 0.025 and 0.07, e.g. between 0.04 and 0.06, e.g. approximately 0.05.

When the impact mitigating structure is curved (e.g. comprises a curved outer and/or inner surface), preferably the radius of curvature of the structure (e.g. of the outer and/or inner surface) is between 60 mm and 140 mm, e.g. between 80 mm and 120 mm, e.g. approximately 100 mm. These are example figures of head curvatures and thus may be appropriate when the impact mitigating structure comprises a helmet, for example. It will be appreciated, e.g. when designing a bespoke impact mitigating structure for an individual, that the curvature of the structure could be tailored to the individual's measurement.

Preferably the invention also extends to an impact mitigating structure per se. Thus when viewed from a further aspect the invention provides an impact mitigating structure for protecting a user against an impact from an object, the impact mitigating structure comprising a cellular structure having a plurality of tessellating cells, wherein the plurality of cells have a plurality of side walls;
wherein the cellular structure comprises a curved inner surface having a radius of curvature between 60 mm and 140 mm;
wherein the width of each of the plurality of cells is between 10 mm and 50 mm;
wherein the thickness of each of the plurality of side walls is between 0.4 mm and 5 mm; and
wherein the height of each of the plurality of cells is between 10 mm and 30 mm.

As will be appreciated by those skilled in the art, this aspect of the present invention can, and preferably does, include any one or more or all of the preferred and optional features of the present invention discussed herein, as appropriate.

It will be appreciated that the methods of the present invention are particularly suited to designing and manufacturing an impact mitigating structure (e.g. a helmet) for a human body, e.g. a human head. Furthermore, the methods of designing the impact mitigating structure mean that it can be customised to the particular measurements of an individual.

Thus preferably the method comprises measuring the shape and size of a (e.g. part of a) human body (e.g. a human head) for which the impact mitigating structure is to be designed and, e.g., manufactured. Preferably the method comprises measuring the (e.g. maximum and/or minimum) radius of curvature of the (e.g. part of the) human body (e.g. human head). This allows the impact mitigating structure to be customised to a particular user, not only in its shape but the values of the characteristic variables for the impact mitigating structure can then be optimised to design a customised impact mitigating structure that maximises the load mitigation efficiency.

With manufacturing techniques such as Additive Manufacturing, it will be appreciated that such customisation is easily facilitated because it simply requires providing a customised set of instructions (rather than a customised moulding, for example, for conventional manufacturing techniques), which embodiments of the method of the present invention are able to generate and provide.

Certain preferred embodiments of the invention will now be described, by way of example only, with reference to the accompanying drawings in which:

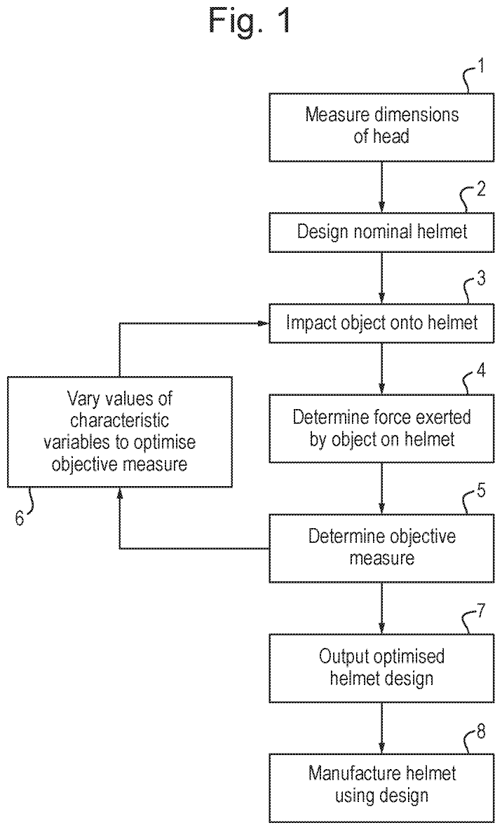

FIG. 1 shows a flow chart detailing the steps of designing and manufacturing a helmet, according to an embodiment of the present invention;

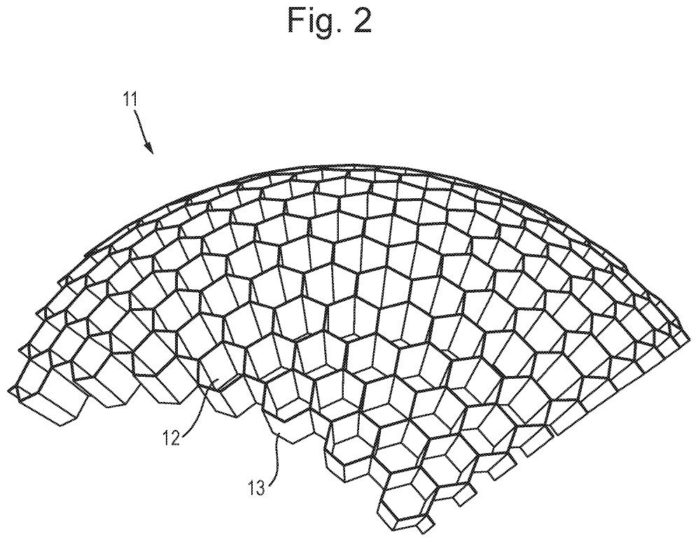

FIG. 2 shows a cellular honeycomb structure designed according to an embodiment of the present invention;

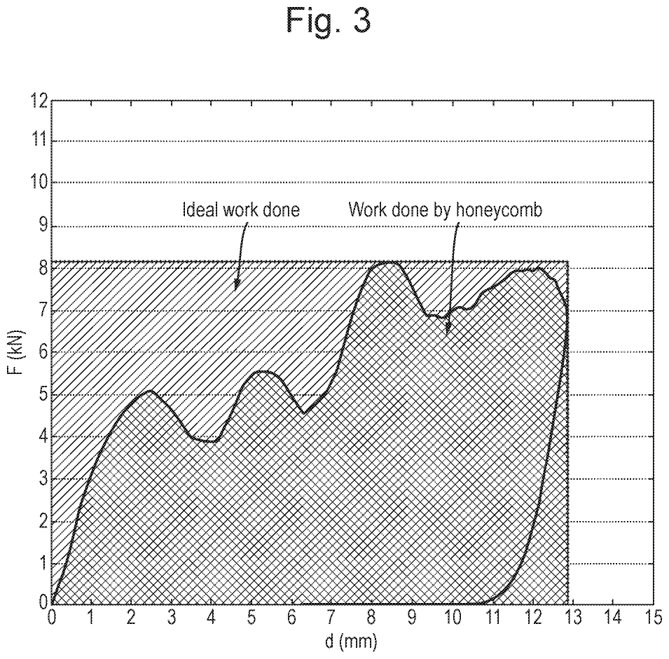

FIG. 3 shows the force-displacement response of an object impacting against a cellular honeycomb structure;

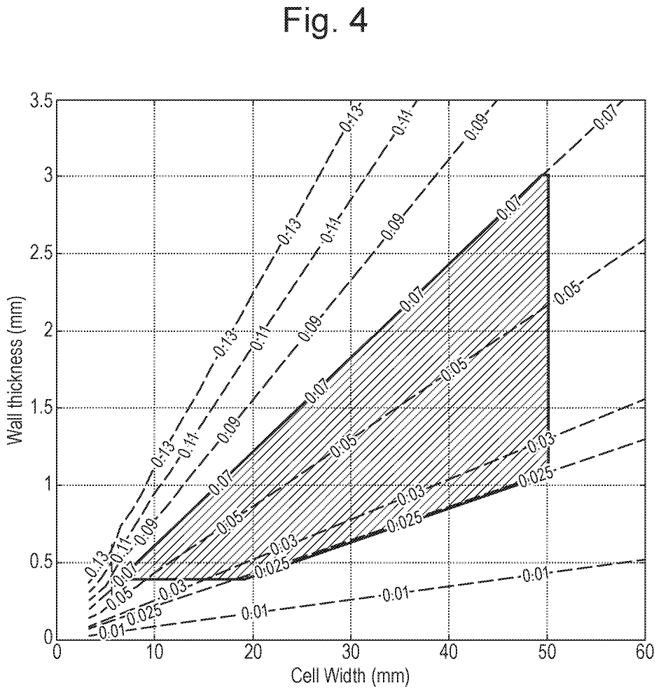

FIG. 4 shows a plot of the cell wall thickness against the cell width for a cellular honeycomb structure;

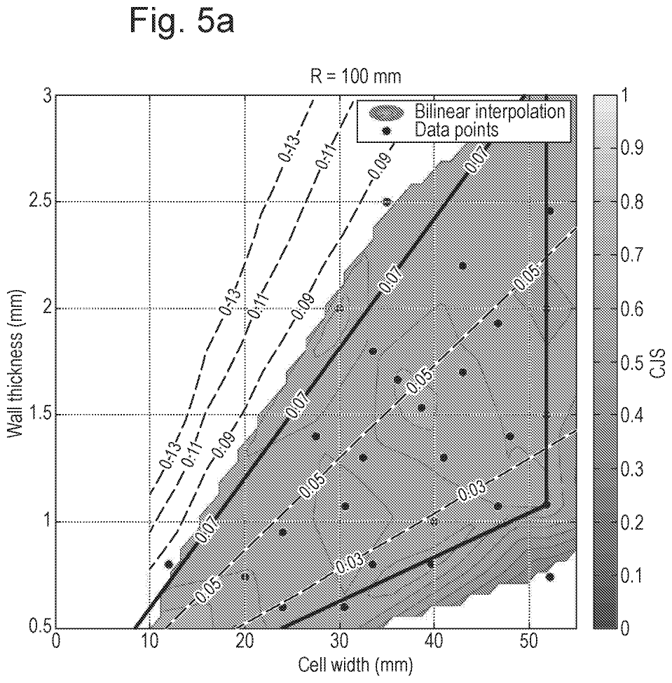

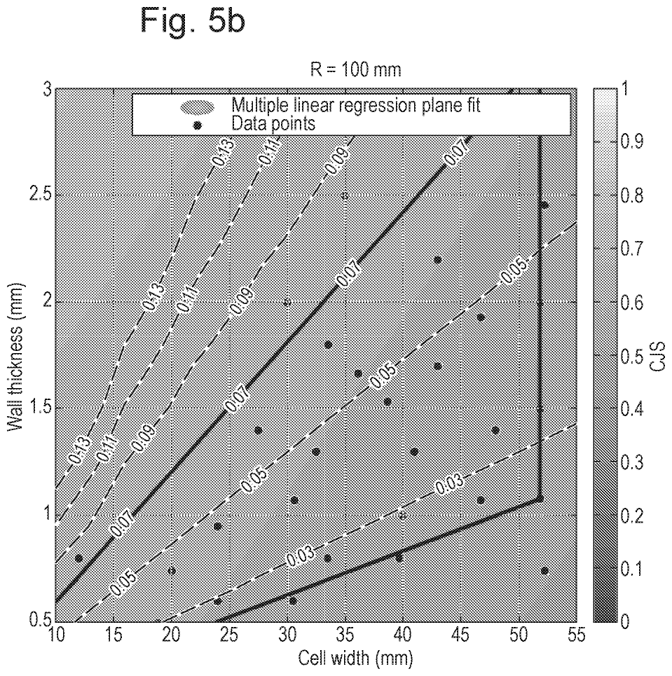

FIGS. 5a, 5b, 6a, 6b, 7a, 7b, 8a, 8b, 9a and 9b show a various objective measures as a function of characteristic variables of the structure being designed according to an embodiment of the present invention.

In order to design and manufacture a (e.g. cycling) helmet that is optimised for its load mitigation, embodiments of the present invention will now be described that provide a method of designing and manufacturing such a helmet.

FIG. 1 shows a flow chart detailing the steps of designing and manufacturing a helmet for mitigating an impact, according to an embodiment of the present invention. First, the dimensions of the head of a user that is to wear the helmet are measured, e.g. using 3D scanning (step 1, FIG. 1).

Using these dimensions, a helmet having a cellular honeycomb structure is designed (step 2, FIG. 1). FIG. 2 shows such a cellular honeycomb structure 11 having a curved surface.

The cellular honeycomb structure 11 is formed with a curved surface and has a plurality of columnar hexagonal tessellating cells 12. The cells 12 are hollow and have flat side walls 13 that each extends in a direction along the surface normal (thus the side walls 13 of any one cell 12 are not parallel to each other as they would be for a cellular structure formed on a flat surface).

The initial design of the cellular honeycomb structure 11 is made with a set of nominal values for a number of characteristic variables. This may depend on the size and shape of the head that has been measured for wearing the helmet. For example, the cell height, the cell width and the cell wall thickness may be chosen as the characteristic variables to be varied. A nominal set of values of a cell height of 20 mm, a cell width of 22 mm and a cell wall thickness of 1.5 mm may be chosen, for example.

For the nominal helmet design and using appropriate material properties, e.g. those of polyamide 11, the impact of an object (a circular disk of radius 100 mm, a mass of 5 kg and a velocity of 5.4 ms⁻¹) onto the outer surface of the cellular honeycomb structure of the helmet is simulated (step 3, FIG. 1) using finite element analysis. The finite element model is calibrated using experimental data from actual impacts of objects onto cellular honeycomb impact mitigating structures.

For the simulated impact, the force exerted by the impacting object on the cellular honeycomb structure as a function of the distance by which the impacting object displaces the outer surface of the cellular honeycomb structure is determined (step 4, FIG. 1). FIG. 3 shows a graph of the force, F, exerted by an object against a cellular honeycomb structure as a function of the displacement, d, of the outer surface of the cellular honeycomb structure by the object (the cellular honeycomb structure for the graph of FIG. 3 has a cell height of 25 mm, a cell width of 30.6 mm, a cell wall thickness of 1.1 mm and a radius of curvature of 100 mm). (In other embodiments, e.g. when determining a different objective measure, the acceleration of the structure, owing to the impact from the impacting object, may instead or additionally be determined, with the acceleration then being used to determine the objective measure (step 5, FIG. 1).)

Using the force-displacement response of the impact (i.e. as shown in FIG. 3), the integral of the force with respect to the displacement is calculated (i.e. the area under the curve shown in FIG. 3). This is the actual work done by the cellular honeycomb structure during the impact. The product of the maximum force and the total displacement is also calculated. This is the ideal work for the cellular honeycomb structure. These two areas are shown in FIG. 3.

The chosen objective measure, e.g. the ratio, of the actual work done by to the ideal work for the cellular honeycomb structure is calculated (step 5, FIG. 1). In this embodiment, this ratio gives a measure of the load mitigation effectiveness of the cellular honeycomb structure. It will be appreciated that the higher the ratio, the closer the actual work done is to the ideal work done and thus the more efficient the cellular honeycomb structure is at mitigating impacts.

The nominal values for the characteristic variables of the cellular honeycomb structure are then changed (step 6, FIG. 1) and the simulation of the object impacting into the cellular honeycomb structure having this new set of values is repeated (step 3, FIG. 1). This enables another force-displacement relationship to be determined (step 4, FIG. 1) and the ratio of the actual work done by to the ideal work for the cellular honeycomb structure to be calculated (step 5, FIG. 1).

These steps are repeated for multiple different sets of values of the characteristic variables, to calculate multiple different ratios in order to ascertain an optimum set of values of the characteristic variables that maximise the ratio (or otherwise optimise the objective measure, as appropriate). The values of the characteristic variables are chosen within a set of boundary conditions, which are shown in FIG. 4.

FIG. 4 shows a plot of acceptable ranges of cell wall thickness against the cell width for a cellular honeycomb structure, on which lines of constant relative density (here approximately 2t/w, where t is the cell wall thickness and w is the cell width) are indicated. FIG. 4 shows the boundaries imposed for the characteristic variables whose values are to be explored during the optimisation of the ratio.

It can be seen from FIG. 4 that the cell wall thickness is varied from 0.4 mm upwards, the cell width is varied up to 50 mm (above this size there is too much variability in load response with impact location owing to the large size of the cells), and the cell wall thickness and the cell width are varied such that the relative density is between 0.025 and 0.07 (this is such that the density is less than foam but large enough to prevent densification).

Once the ratios corresponding to the values of the characteristic variables within the boundary conditions have been calculated, e.g. for a particular cell height of the cellular honeycomb structure, the set of values of the characteristic variables are chosen (e.g. numerically) that maximise the target objective measure, e.g. the ratio, of the actual work done by to the ideal work for the cellular honeycomb structure are output as an optimised design for the helmet (step 7, FIG. 1).

FIGS. 5a and 5b show the ratio (“CJS”) as a function of the cell width and the wall thickness, with the boundaries shown in FIG. 4 imposed. In FIG. 5a the ratio has been fit using bilinear interpolation; in FIG. 5b the ratio has been fit using multiple linear regression. In these figures, the “Data points” each represent data from a single simulation.

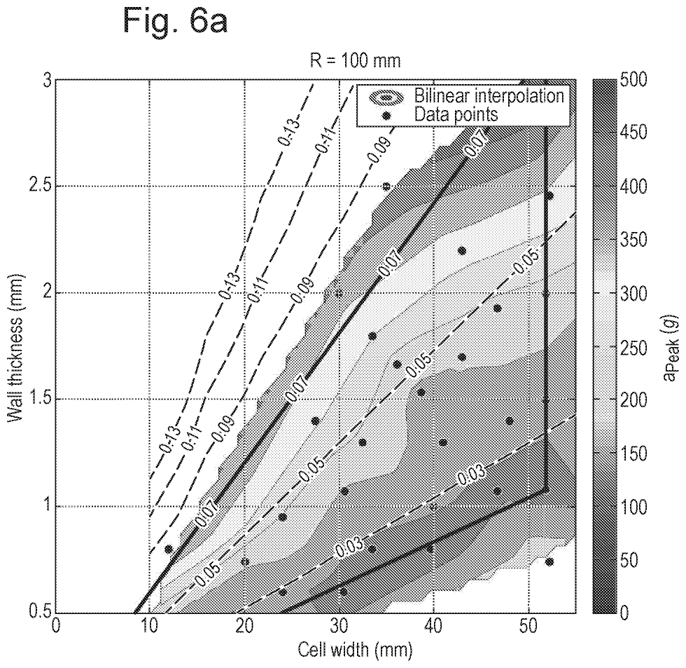

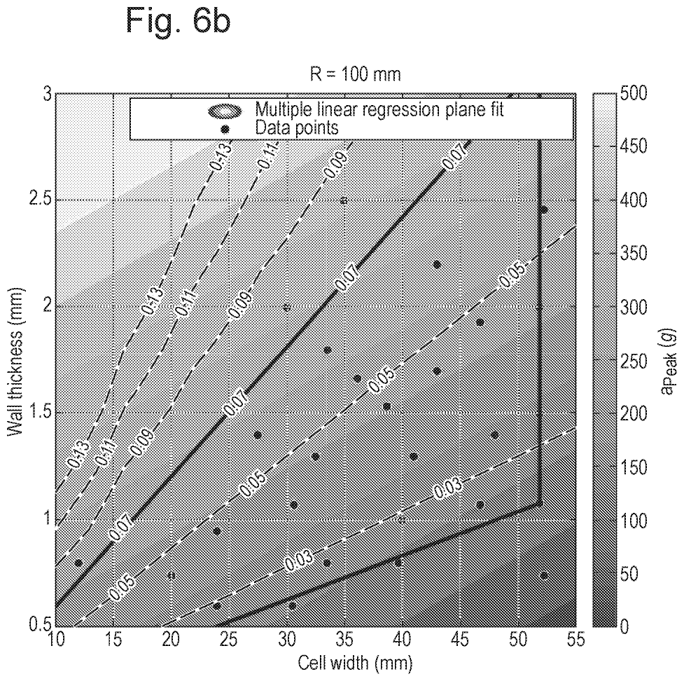

FIGS. 6a and 6b show a different objective measure, the peak acceleration (a peak), as a function of the cell width and the wall thickness, with the boundaries shown in FIG. 4 imposed. In FIG. 6a the peak acceleration has been fit using bilinear interpolation; in FIG. 6b the peak acceleration has been fit using multiple linear regression. In these figures, the “Data points” each represent data from a single simulation.

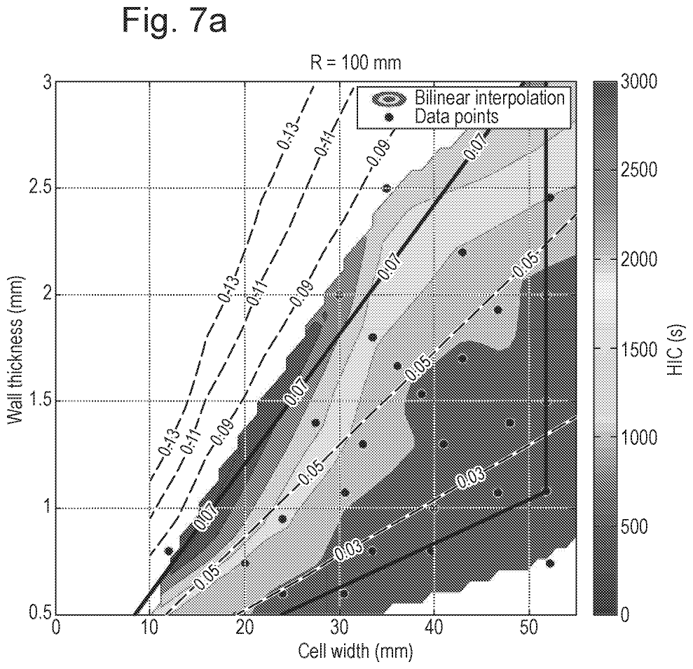

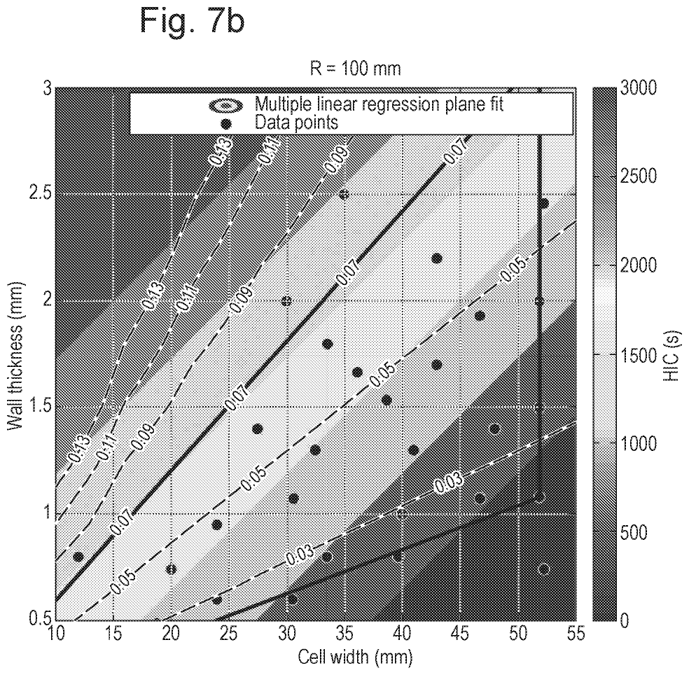

FIGS. 7a and 7b show a different objective measure, the Head Injury Criterion (HIC), as a function of the cell width and the wall thickness, with the boundaries shown in FIG. 4 imposed. In FIG. 7a the HIC has been fit using bilinear interpolation; in FIG. 7b the HIC has been fit using multiple linear regression. In these figures, the “Data points” each represent data from a single simulation.

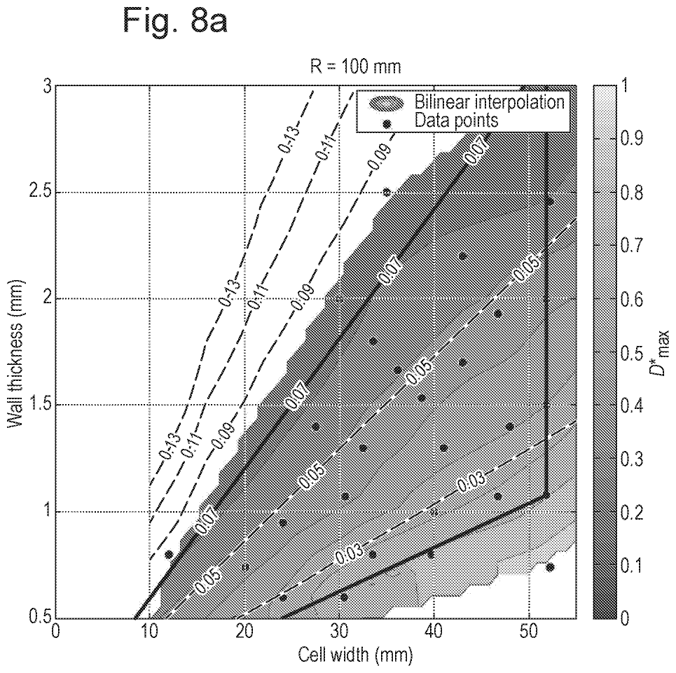

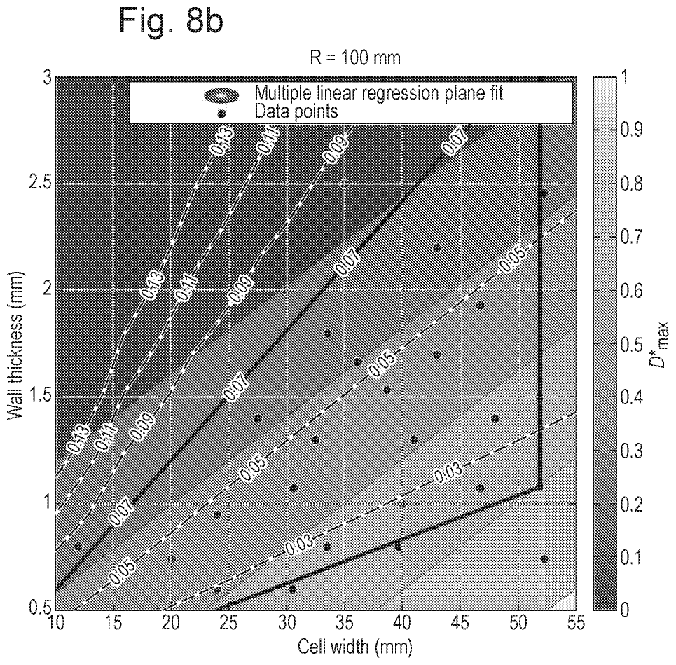

FIGS. 8a and 8b show a different objective measure, the normalised displacement (Dₘₐₓ) as a function of the cell width and the wall thickness, with the boundaries shown in FIG. 4 imposed. In FIG. 8a the normalised displacement has been fit using bilinear interpolation; in FIG. 8b the normalised displacement has been fit using multiple linear regression. In these figures, the “Data points” each represent data from a single simulation.

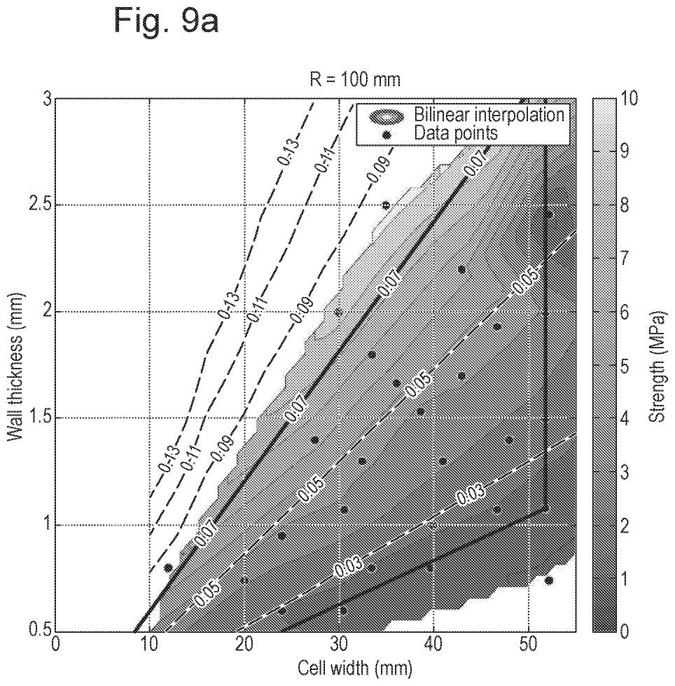

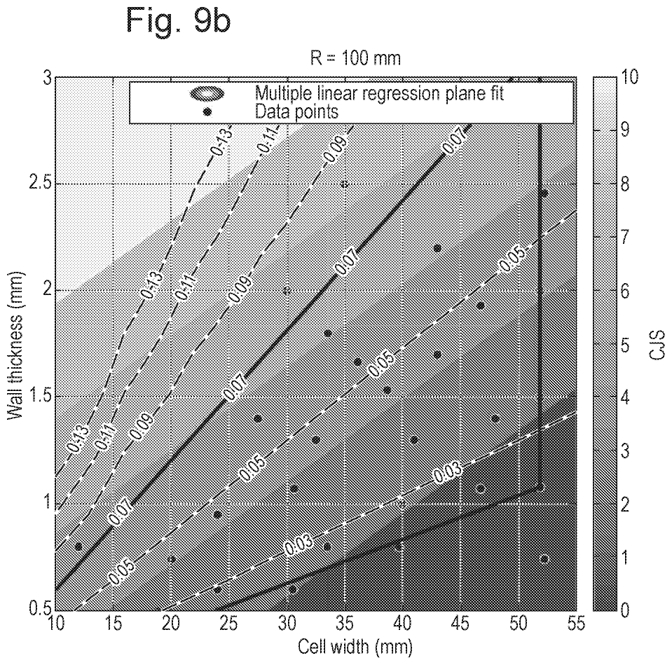

FIGS. 9a and 9b show a different objective measure, the peak stress (strength) as a function of the cell width and the wall thickness, with the boundaries shown in FIG. 4 imposed. In FIG. 9a the strength has been fit using bilinear interpolation; in FIG. 9b the strength has been fit using multiple linear regression. In these figures, the “Data points” each represent data from a single simulation.

After the set of values of the characteristic variables that optimise the objective measure has been determined, a helmet can then be manufactured according to the optimised design (step 8, FIG. 1), e.g. using polyamide 11. The Applicant has found that when the ratio of the actual work done to the ideal work for a cellular honeycomb structure is chosen as the objective measure, the maximum value obtained is 0.73, which is greater than twice the ratio (approximately 0.35) found for expanded polystyrene used in conventional bicycle helmets.

It will be seen from the above, that at least preferred embodiments of the invention provide a method for designing (and, e.g., manufacturing) an impact mitigating structure, as well as the impact mitigating structure itself. Designing an impact mitigating structure in this way helps to optimise the load mitigation of the structure and thus improve the safety and/or performance able to be provided by the structure. The design method may also be able to provide a customised design for a particular shape of impact mitigating structure, e.g. to fit a user. This may help to select the optimal impact mitigating structure for a particular surface curvature of the structure and/or a particular impact scenario (e.g. a maximum force that needs to be protected against).

The Applicant has found that structures designed using at least preferred embodiments of the method of the present invention may provide approximately a two-fold improvement in load mitigation compared to conventional foams that are conventionally used in crash helmets, for example.

While the above embodiments have been described primarily with reference to helmets, it will be appreciated that the load mitigation structure may be used in any suitable and desired type of structure that may be subject to an impact. This includes shields, body armour and (e.g. soles of) shoes, for example. During an impact, the load mitigation structure aims to make the load (on the structure) and, e.g., also the deceleration (of the object impacting the structure or the structure itself, depending on the inertial frame of reference) consistent. In a load mitigation structure such as a helmet which may experience a blow to the user's head, this helps to protect the user's head. In a load mitigation structure in a shoe, for example, this may help to improve the wearer's running efficiency.

1. A method of designing an impact mitigating structure; the method comprising:
determining the force exerted by an object on the impact mitigating structure as a function of the distance by which the object displaces an outer surface of the impact mitigating structure during an impact of the object onto the outer surface of the impact mitigating structure;
calculating a ratio of the integral of the force exerted by the object on the impact mitigating structure with respect to the distance by which the object displaces the outer surface of the impact mitigating structure during the impact to the product of the maximum force exerted by the object on the impact mitigating structure during the impact and the total distance by which the object displaces the outer surface of the impact mitigating structure during the impact; and
determining the respective values of one or more characteristic variables of the impact mitigating structure that maximise the ratio for use in designing the impact mitigating structure.

2. The method as claimed in claim 1, wherein the impact mitigating structure comprises a cellular structure or a lattice structure.

3. The method as claimed in claim 2, wherein the cellular structure comprises a plurality of tessellating cells, wherein the plurality of cells each have a plurality of side walls that are shared with adjacent cells, and the plurality of side walls extend perpendiclarly to the surface of the impact mitigating structure and the cells each have a polygon shaped cross-section in a direction substantially perpendicular to the direction in which the side walls extend.

4-5. (canceled)

6. The method as claimed in claim 3, wherein the one or more characteristic variables comprise one or more of: the thickness of the side walls, the characteristic width of the cells, the height of the cells and the shape of the cells.

7. The method as claimed in claim 6, wherein the characteristic width of the cells is between 10 mm and 50 mm, and thickness of the side walls of the cells is between 0.4 mm and 5 mm and the height of the cells is between 10 mm and 30 mm.

8-9. (canceled)

10. The method as claimed in claim 6, wherein the shape of the cells has a hexagonal cross-section.

11. The method as claimed in claim 6, wherein a relative density of the cells is between 0.025 and 0.07, wherein the relative density is approximately 2t/w, where t is the thickness of the side walls of the cells and w is the characteristic width of the cells.

12. The method as claimed in claim 2, wherein the lattice structure comprises a plurality of struts extending between a plurality of vertices, and wherein the one or more characteristic variables comprise one or more of: the length of the struts, the thickness of the struts and the geometry of the struts.

13. (canceled)

14. The method as claimed in claim 1, wherein the impact mitigating structure comprises a curved outer and/or inner surface, and wherein the radius of curvature of the impact mitigating structure is between 60 mm and 140 mm.

15. (canceled)

16. The method as claimed in claim 1, the method further comprising impacting an object on the impact mitigating structure to determine the force exerted by the object on the impact mitigating structure as a function of the distance by which the object displaces the outer surface of the impact mitigating structure during an impact of the object onto the outer surface of the impact mitigating structure.

17. The method as claimed in claim 1, wherein the step of determining the respective values of one or more characteristic variables of the impact mitigating structure that maximise the ratio comprises repeating the steps of determining the force exerted by an object on the impact mitigating structure and calculating the ratio for a plurality of different respective values of the one or more characteristic variables.

18. The method as claimed in claim 1, the method further comprising setting one or more constraints and determining the respective values of one or more characteristic variables of the impact mitigating structure that maximise the ratio within the one or more constraints.

19. The method as claimed in claim 18, wherein the one or more constraints comprises a maximum allowed deceleration of 250 g when using the impact mitigating structure.

20. A method of designing an impact mitigating structure; the method comprising:
determining the acceleration of the impact mitigating structure during an impact of an object onto the outer surface of the impact mitigating structure;
calculating, using the acceleration, an objective measure of the ability of the impact mitigating structure to mitigate the impact of the object on the impact mitigating structure; and
determining the respective values of one or more characteristic variables of the impact mitigating structure that optimise the objective measure for use in designing the impact mitigating structure.

21-22. (canceled)

23. The method as claimed in claim 20, the method further comprising manufacturing the impact mitigating structure using the respective values of the one or more characteristic variables of the impact mitigating structure that have been determined.

24. The method as claimed in claim 23, wherein the impact mitigating structure is manufactured using Additive Manufacturing.

25. The method as claimed in claim 23, the method further comprising generating a set of Additive Manufacturing instructions using the respective values of the one or more characteristic variables of the impact mitigating structure that have been determined; and manufacturing the impact mitigating structure according to the Additive Manufacturing instructions.

26-30. (canceled)

31. The method as claimed in claim 1, the method further comprising manufacturing the impact mitigating structure using the respective values of the one or more characteristic variables of the impact mitigating structure that have been determined.

32. The method as claimed in claim 31, wherein the impact mitigating structure is manufactured using Additive Manufacturing.

33. The method as claimed in claim 31, the method further comprising generating a set of Additive Manufacturing instructions using the respective values of the one or more characteristic variables of the impact mitigating structure that have been determined; and manufacturing the impact mitigating structure according to the Additive Manufacturing instructions.
